(19) United States
(12) Patent Application Publication
(10) Pub. No.: US 2002/0034352 A1
(43) Pub. Date: Mar. 21, 2002

(54) Optical switch device having an integrated polymer switching element

(76) Inventors: Quinton L. Williams, Stone Mountain, GA (US); Gregory E. Williams, Fayetteville, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/939,113

(22) Filed: Aug. 24, 2001

Related U.S. Application Data
(60) Provisional application No. 60/228,195, filed on Aug. 25, 2000.

(51) Int. Cl. G02B 6/35

(52) U.S. Cl. 385/16

(57) ABSTRACT

A switching element formed with at least a pair of intersecting channel optical waveguide paths. A polymer switching element is formed across the waveguide paths at the point of intersection. The offstate refractive index of the polymer switching element substantially matches the refractive index of the waveguide paths. Optical switching between the waveguides is achieved by changing the refractive index of the polymer switching element by applying heat to the polymer switching element. The heat can be applied by a thin-film heater formed on top of the polymer switching element at the switch intersection. The application of heat causes total internal reflection in the polymer switching element to divert light from the first or input waveguide path to the second or cross-state output waveguide path.

### CROSS-REFERENCE TO RELATED APPLICATION

This patent application claims priority in the United States under 35 U.S.C. 119, and under the Paris Convention worldwide, to the benefit of the filing date of WILLIAMS, U.S. provisional patent application Serial No. 60/228,195, entitled SCABLE NON-BLOCKING 2×2 ALL OPTICAL SWITCH, which was filed on Aug. 25, 2000, and which is incorporated herein by reference.

### BACKGROUND OF THE INVENTION

The present invention generally relates to optical switching, and in particular to an optical switch device for controlling energy propagation, particularly optical beams propagating through optical waveguide paths, making use of an optical switching material which changes refractive index when heat is applied via a heat generator. The application of heat to the optical switching material changes the switching material from a transmissive state to a reflective state to switch the optical beams from one waveguide path to another.

The most challenging technical task at the very heart of any all-optical network is the switching matrix, which physically routes light beams into different optical waveguide paths. U.S. Pat. Nos. 5,699,462 and 6,055,344 to Foquet et al. describe a switching matrix for routing optical beams from a number of parallel input optical fibers to any one of a number of parallel output optical fibers. The optical switch is based on total internal reflection in a planar lightwave circuit with vertical fluid fill-holes. Foquet utilizes the presence or absence of bubbles of fluid to direct the path of light propagation in a planar waveguide device.

Mach-Zehnder Interferometer (MZI) switches utilizing thermo-optic and electro-optic effects also have been demonstrated. MZI switches are also examples of devices that are of the planar waveguide type. However, depending on the channel count (for example a 16×16 matrix), one MZI switch can fill an entire six-inch wafer. The large space requirement is due to the relatively long interaction length (—tens of millimeters) that is required to achieve complete energy transfer from one waveguide to an adjacent waveguide. MZI devices, particularly those that are based upon the electro-optic effect, usually consume an enormous amount of power to function properly.

Optical switching utilizing micro electromechanical mirrors (MEMS) to steer beams of light also has been demonstrated. MEMS, also called lightwave micromachines, are fabricated and integrated directly onto wafers, making this a potentially low cost technology. However, because the light beams in MEMS devices propagate in free space, there is considerable concern that there may be optical beam divergence when these switches are scaled up to a large number of channels. Also, the strict angular alignment tolerances of the mirrors and the reliability of thousands of moving mechanical parts are an extremely difficult challenge to overcome in developing practical MEMS devices.

U.S. Pat. No. 4,753,505 to Mikami et al. describes a thermo-optic switch device that utilizes an optical material that varies in refractive index with the application of heat and utilizes a temperature gradient in the optical material to deflect the path of light beam propagation. This device, like most other thermo-optic based devices, typically make the passive waveguide path and the active switching region entirely with the same optical material.

It would be desirable to provide a solid state optical switch, which is compact and does not require any moving parts.

### SUMMARY OF THE INVENTION

The present invention utilizes an optical material that is placed at the intersection of two crossing light beam waveguides. The device is selectively switched from a transmissive state to a reflective state by applying heat to the optical material via a thin-film metal heater. An application of the appropriate amount of heat to the optical material causes a beam of light to have its path deflected from one light path to the other. This is accomplished through total internal reflection utilizing an angle of incidence that is greater than a critical angle of incidence.

According to the invention, the switching material operation provides a way for achieving all-optical switching in a compact, scalable, non-blocking scheme in an optical integrated circuit design. The switch can be utilized as the unit cell for building a switch matrix that can be used as an all-optical switching structure or as the foundation for other switch based photonic devices. Because the light is confined within a waveguide structure at all times, the device should achieve low-loss transmission.

The invention provides a solid-state solution to all-optical switching, including methods of forming and operating such devices. The result is a low-loss, robust and effective switching device suitable for various telecommunication applications that require either a low or high channel count optical switch.

### BRIEF DESCRIPTION OF THE DRAWINGS

Benefits and further features of the present invention will be apparent from a detailed description of preferred embodiment thereof taken in conjunction with the following drawings, wherein like elements are referred to with like reference numbers, and wherein:

FIGS. 1A-1D illustrate the cross-sections of some common types of optical waveguide structures in which the present invention can be utilized.

FIG. 2 illustrates a top plan functional view of a four by four-optical switching matrix.

FIG. 3 is a diagrammatic illustration of the strategic placement of the optical switching element for changing the state of the switch from transmissive to reflective.

FIG. 4 illustrates the principle of total internal reflection that causes the optical beam's path deflection.

FIG. 5 illustrates an embedded waveguide embodiment of the invention.

FIG. 6 illustrates a cross-section of the present invention at a waveguide intersection with a thin-film heater on top.

### DETAILED DESCRIPTION OF THE INVENTION

As a preliminary matter, those persons skilled in the art readily will understand that, in view of the following detailed description of the preferred devices and methods of the present invention, the present invention is susceptible of broad utility and application. Many methods, embodiments, and adaptations of the present invention other than those herein described, as well as many variations, modifications, and equivalent arrangements, will be apparent from or reasonably suggested by the present invention and the following detailed description thereof, without departing from the substance or scope of the present invention. Accordingly, while the present invention is described herein in detail in relation to preferred methods and devices, it is to be understood that this detailed description only is illustrative and exemplary of the present invention and is made merely for purposes of providing a full and enabling disclosure of the invention. The detailed description set forth herein is not intended nor is to be construed to limit the present invention or otherwise to exclude any such other embodiments, adaptations, variations, modifications and equivalent arrangements of the present invention, which is limited solely by the claims appended hereto and the equivalents thereof.

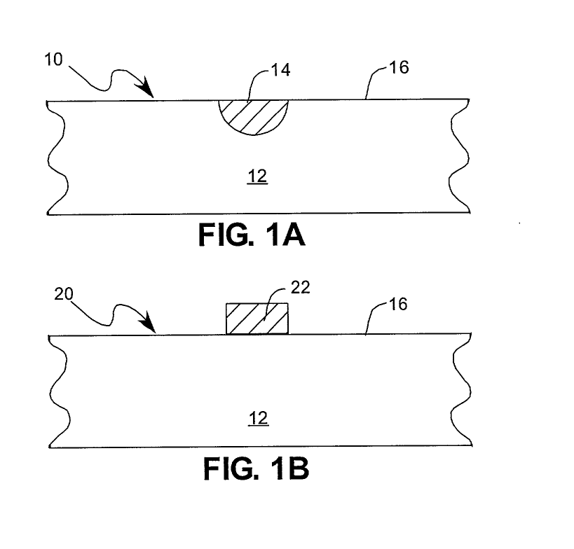

FIGS. 1A-1D illustrate different types of optical waveguide structures which can be utilized with the present invention. FIG. 1A illustrates a diffused waveguide structure 10. A substrate 12, such as a portion of a silicon wafer, includes a diffused waveguide structure 14 formed in a top surface 16 of the wafer 12, in a conventional manner.

A ridge type waveguide structure 20 is illustrated in FIG. 1B. In this structure 20, a waveguide 22 is formed on top of the top surface 16 of the wafer 12, again in a known manner.

One preferable type of waveguide structure is a buried waveguide structure 30, as illustrated in FIG. 1C. In the waveguide structure 30, a second body of material 32 is formed on the top surface 16 of the substrate 12, with one or more waveguides 34 buried within the body 32. The buried channel waveguides 34 are fabricated utilizing conventional photolithography and reactive ion etching to form, align and place the waveguides 34, as desired. The substrate 12 generally is formed from silicon or quartz. A first layer of cladding material, such as SiO₂, then is deposited or otherwise formed on top of the surface 16 to a thickness “a” desired for the waveguide 34 to be deposited as a layer onto the first layer of thickness a (not illustrated). The waveguide 34 then is etched from the waveguide layer (not illustrated) to the desired shape and alignment as illustrated in FIG. 1C. The waveguide 34 preferably will be dimensioned on the order of a range of typically four (4) to eight (8) microns square. This geometry matches the circularly symmetric Gaussian mode beam profile, which emanates from a standard single mode optical fiber. This modal distribution ensures that loss in the propagated light beam due to mode field diameter mismatch will be minimal. The cladding material then is deposited over the waveguide 34 to finish forming the body 32 as illustrated.

A rib type waveguide structure 36 is illustrated in FIG. 1D. In this structure 36, a waveguide 37 is formed like the buried waveguide structure 30. The, waveguide 37 is deposited like the layer 34 and then etched to form a rib 28 on top of the top surface 16 of the wafer 12. The cladding material again is deposited to form the body 32, again in a known manner.

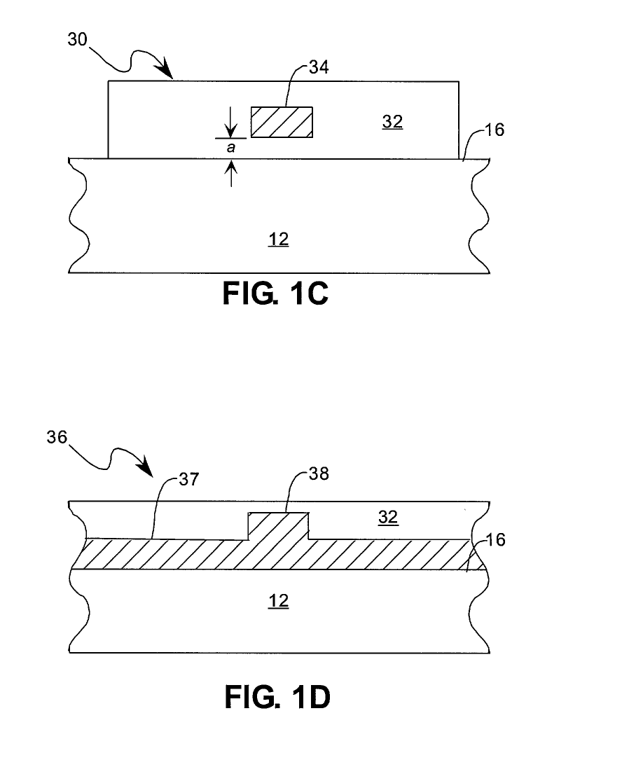

A functional four by four (4×4) switching matrix 40 is illustrated in FIG. 2. The matrix 40 includes four input light beam paths 42, 44, 46 and 48, with four output light beam paths 50, 52, 54 and 56. In accordance with the present invention, each input light beam path 42, 44, 46 and 48 has an intersection 58 with each output light beam path 50, 52, 54 and 56. Each of the intersections 58 also includes a switching element 60 of the present invention, which will allow a light beam to pass through it when inactive, but will totally reflect the light beam into a second path when activated.

For example, a light beam on the input path 42 will pass through the first intersection 58 if the switching element 60 is inactivated. However, if the switching element 60 is activated, the light beam will be reflected into the output path 50. By selective activation of the switching elements 60, each input path 42, 44, 46 and 48 can couple a light beam to any one of the output paths 50, 52, 54 and 56.

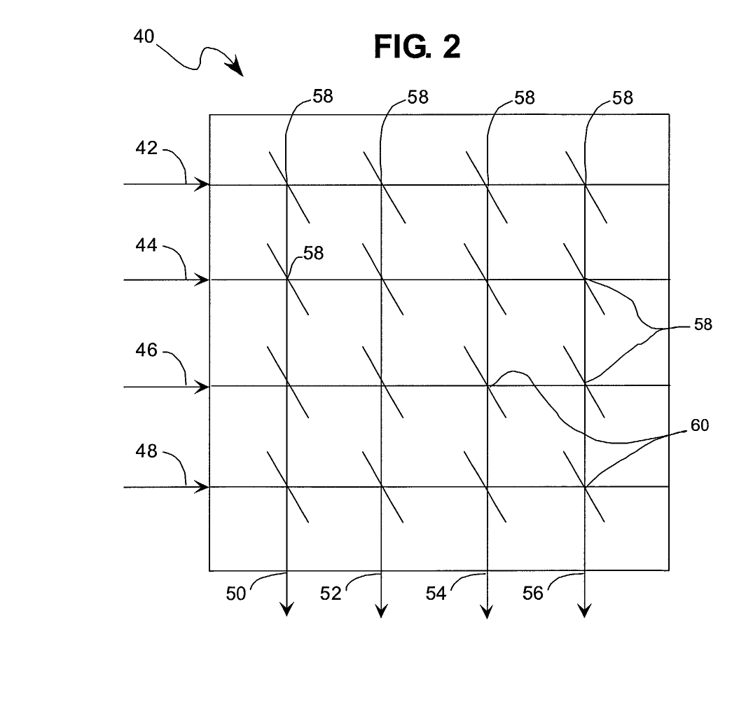

Referring now to FIG. 3, the strategic placement of a thermo-optic switching element 70 of the present invention, placed between intersecting optical waveguide paths 72, 74, 76 and 78, is illustrated. The material 70 is a polymer, such as a cross-linked poly(acrylates), whose non activated or offstate index of refraction substantially has been tailored to match the index of refraction of the material forming the waveguide paths 72, 74, 76 and 78. A material is described as thermo-optic when its index of refraction can be changed with the application of heat. The material 70 is strategically placed by removing a small cross-section of the waveguide material using a plasma etch process (such as Reactive Ion Etching) to create a channel or section through the waveguide intersection 58. An ultraviolet (UV) light curable difunctional acrylate monomer is introduced into the channel via a precision liquid dispenser (not illustrated). The monomer is then irradiated with UV light for polymerization into a stress-free solid polymer material. Once polymerization is complete, the material 70 is locked into place in the switch.

In the switching operation, the optical material 70 is heated, preferably with a thin-film metal heater 80 that is thermally deposited or evaporated onto the device surface. The heater 80 is made to substantially completely cover the polymer section 70 to form the active switching element in the device. When the heater 80 is in the “off” state (hereinafter “offstate”), no heat is applied to the polymer section 70 and its index of refraction substantially is matched with that of the optical waveguides 72, 74, 76 and 78. Thus, a light beam 82 that is propagating through the optical waveguide path 72 will travel unimpeded through the intersection 58 into the optical waveguide path 74. Similarly, a light beam will travel through the optical waveguide path 76 into the optical waveguide path 78.

When the heater 80 is in the “on” state (hereinafter “onstate”), heat is applied to the polymer material 70 causing its index of refraction to be lowered. The light beam 82 that is propagating through the optical waveguide path 72 will be deflected by the section 70 into the second or cross-path optical waveguide path 78, forming a light beam 82′, if the angle of incidence with the section 70 is greater than the critical angle for total internal reflection. Similarly, a light beam that is propagating through the optical waveguide path 76 is deflected by total internal reflection into the optical waveguide path 74 if the heater 80 is in the “on” state.

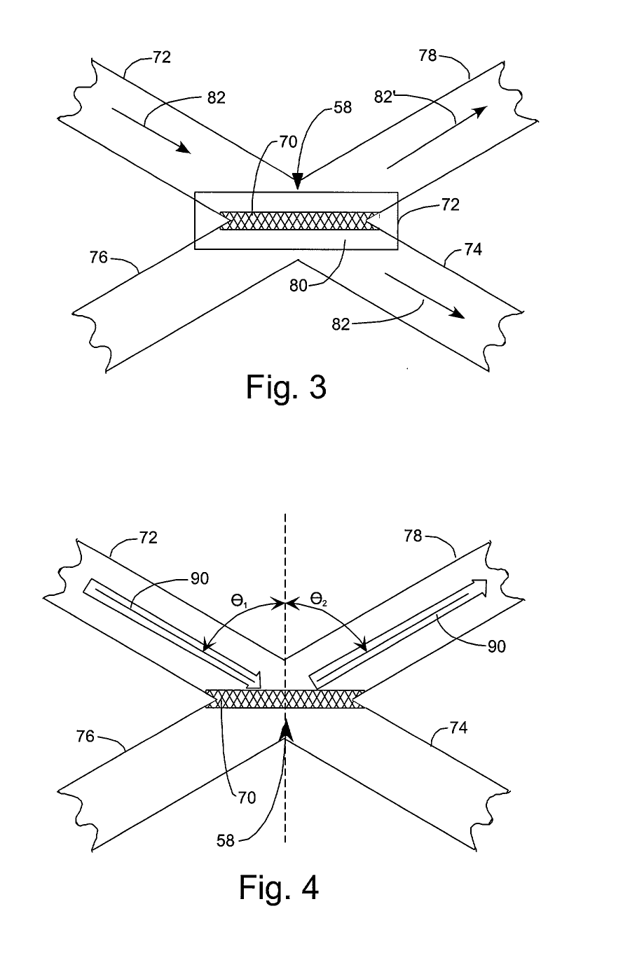

Referring to FIG. 4, there is illustrated a diagram of an optical beam 90 being deflected from the optical waveguide path 72 into the optical waveguide path 78 due to the optical beam 90 having an angle of incidence with the section 70 that is greater than the critical angle for the condition of total internal reflection. The critical angle is found using the well-known Snell's Law (n₁ sin θ₁=n_{2 sin θ}₂) which mathematically describes reflection and refraction across the interface of different media. Calculations reveal that the polymer material 70 must have its index of refraction lowered by an amount ˜10⁻² relative to that of the optical waveguide paths 72, 74, 76 and 78 to obtain incident waveguide angles that are reasonable for manufacturing.

The polymer material 70, of the present invention is strategically placed at the intersection 58 of the waveguides. The polymer material is chosen such that the inactive or offstate index of refraction substantially matches the index of refraction of the material of the waveguides. The activated or onstate of the material 70, is provided by applying heat to the material which affects a decrease in the refractive index. The refractive index is decreased by the amount ˜10⁻² to cause total internal reflection. Total internal reflection occurs when light (the light beams) in the wave guide (having one index of refraction) strikes the interface formed by the section 70, (having a second different index of refraction) at an angle greater than the critical angle.

The minimum width of the polymer 70, should be on the order of not less than twice the wavelength of the light propagating in the waveguide to affect total internal reflection. For a reasonable total internal reflection operation, the offstate index of refraction of the polymer material 70, should lie between about 1.44 to 1.70. The index of refraction of the polymer material 70 is substantially matched with a value determined based upon the material used for the waveguides. The doped silica used in one specific embodiment of the present invention has an index of refraction in the range of approximately 1.453 to 1.732. This range may vary depending upon the type and amount of dopants and is defined by the formula:

Delta=(n₁−n₂)/n₁

The value of Delta ranges in the formula from 0.25 % to 1.25 %.

The index of refraction of polymer materials varies as a function of temperature. Two examples of polymer materials used in the present invention have thermal coefficients of about −1×10⁻⁴/degree Centigrade for PMMA and other acrylates and about −3×10⁻⁴/degree Centigrade for F/Diacrylates. The temperature may vary over a wide range, and is chosen for the present invention to be a temperature differential of 0 to 300 degrees Centigrade to obtain the required change in the index of refraction. The temperature range is of course material dependent.

The loss coefficient of the polymer material is approximately about 0.1 to 0.3 dB/cm. The light (light beam) propagating within the waveguides will only efficiently transmit through a very thin layer of the polymer material. Preferably, the layer of the polymer section 70 should have an optimum thickness on the order of about three (3) to four (4) microns. This results in an acceptable loss of only about 0.0003 to 0.0009 dB per intersection 58.

An acceptable difunctional acrylate structure is shown by the following formula:

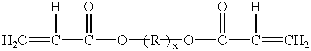

The generalized structure of the difunctional acrylates for R includes the following: R:═CH₂, CF₂, CF₂CF₂O, CH₂(CF₂)ₘ CH₂, ethoxylated bisphenol A.

Two specific examples of the difinctional acrylates are:

2,2,3,3,4,4,5,5, -Octafluoro-1,6-diacrylate (OFHDDA, R═CH₂(CF₂ )₄CH₂in the above formula) monomer and 1,6 -hexanediol diacrylate (HDODA, R═(CH₂)₆) were purified and freed from inhibitor before use.

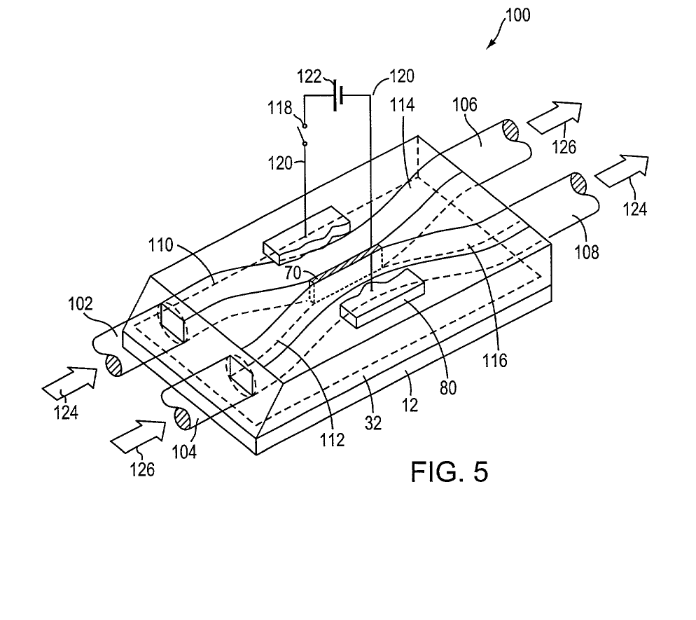

FIG. 5 illustrates an embodiment 100 of the optical switch device of the present invention with single mode buried channel optical waveguide paths along with optical fibers for launching light beams into and receiving light beams from the device 100. Single mode optical fibers 102, 104, 106 and 108 are connected to single mode buried channel optical waveguide paths 110, 112, 114 and 116, respectively. The optical waveguide paths are preferably made from glass-like material (such as SiOxNy or Ge-doped silica) and are substantially square in geometry. The optical switching material 70 is strategically placed across the intersection of the optical waveguide paths 110, 112, 114 and 116. The cladding material 32 is made from SiO₂ and the substrate 12 is formed from either silicon or quartz.

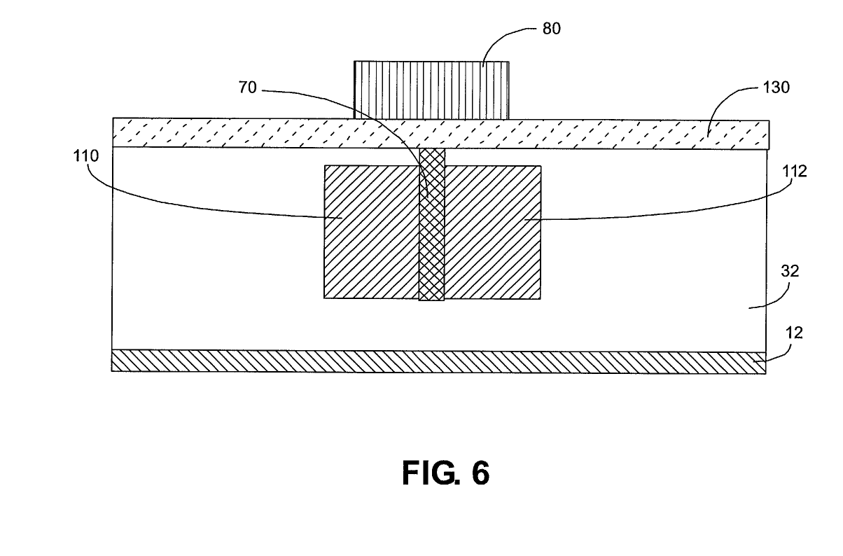

The thin film metal heater 80 then is deposited, such as by being thermally evaporated on top of the optical cladding material 32. The thin film metal heater (thickness between 1000-2000 Å) preferably is made of either Ni−Cr or Aluminum. A buffer layer of SiO₂ (see FIG. 6) is deposited or placed between the metal heater 80 and the optical material 70. The buffer layer is necessary to prevent the metal 80 from highly absorbing the TM mode as light beams pass through the optical material 70 located beneath the heater 80, to allow the device 100 to remain low loss.

Heat is produced in the heater 80 when a voltage switch 118 is “on” and a circuit made from a pair of conductors 120 and a DC voltage supply 122 is closed. The thermal conductivity of the optical material 70 causes it to heat throughout, thus lowering the material's index of refraction. Optical switching is achieved when the optical material's index of refraction is lowered beyond a calculated threshold value by adjusting the DC voltage appropriately. When the voltage switch 118 is ″ off′, no heat is produced and the material 70 remains at its normal index of refraction value, allowing light beams to pass therethrough.

The switch 100 includes a pair of waveguide paths 102, 108 and 104, 106. When the heater 80 is turned off, a light beam 124 from the optical fiber 102 will pass through the transparent offstate material 70 and out the fiber 108. In a like manner a light beam 126 will pass from the fiber 104 to the fiber 106 through the material 70. When the heater 80 is turned on, however, the outputs are reversed. The light beam 124 will be reflected by the onstate material 70 and emerge from the fiber 106, while the light beam 126 will be reflected and emerge from the fiber 108 instead of the fiber 106.

FIG. 6 illustrates a cross-section of the optical switch device 100 at the point 58 of intersecting glass optical waveguide paths with the strategically placed optical material 70. The thin-film metal heater 80 is located on top of the device 100, with a buffer layer 130 formed between the heater 80 and the material 70. The thin dielectric buffer layer 130 (1000-1500 Å thickness) of SiO₂ can be RF sputtered onto the device surface. The thin dielectric buffer layer 130, is preferably used to insulate the material 70 and to reduce the optical loss and birefringence caused by the section of the material 70, being inserted through the cladding and into the waveguide.

1. An optical switch device, comprising:
a first optical waveguide path formed in a glass-like material;
a second optical waveguide path formed in said glass-like material and intersecting said first optical waveguide path at an angle greater than a predetermined critical angle to provide substantially total internal reflection;
a strategically placed optical switching element intersecting said intersecting waveguide paths, said element being thermo-optic and having an index of refraction substantially tailored to match the index of refraction of said waveguide paths; and
a thin-film metal heat generator for changing the index of refraction of said optical element to redirect an optical beam whose angle of incidence is greater than said critical angle for total internal reflection which causes said optical beam to be substantially deflected from said first optical waveguide path into said second optical waveguide path.

2. The optical switch device as defined in claim 1, wherein said optical waveguide paths are buried channel waveguides.

3. The optical switch device as defined in claim 1, wherein said optical waveguide paths are formed from Ge-doped silica.

4. The optical switch device as defined in claim 1, wherein said optical waveguide paths are formed from Silicon Oxynitride.

5. The optical switch device as defined in claim 1, wherein said first and second optical waveguide paths are designed for single mode light beam transmission.

6. The optical switch device as defined in claim 1, wherein said optical element is a polymer capable of producing a change in index of refraction that is sufficient to redirect an optical beam through total internal reflection.

7. The optical switch device as defined in claim 1, wherein said thin-film heat generator is formed above said strategically placed optical element.

8. The optical switch device as defined in claim 7, including a buffer layer formed over said strategically placed optical element and said thin-film heat generator is deposited on said buffer layer directly above said strategically placed optical element.

9. The optical switch device as defined in claim 1, wherein said optical element has said index of refraction substantially tailored to match the index of refraction of said waveguide paths in an offstate of said optical element.

10. The optical switch device as defined in claim 1, wherein said thin-film heat generator is formed from Ni-Cr.

11. The optical switch device as defined in claim 1, wherein said thin-film heat generator is formed from Aluminum.

12. The optical switch device as defined in claim 6, wherein said optical element is a polymer formed from a photosensitive monomer.

13. The optical switch device as defined in claim 12, wherein said photosensitive monomer is a difunctional monomer cross-linked when exposed to ultraviolet light to form said optical element.

14. The optical switch device as defined in claim 1, wherein said optical element has a minimum thickness on the order of at least twice the wavelength of said optical beam.

15. The optical switch device as defined in claim 14, wherein said optical element has an optimum thickness on the order of three to four microns.

16. The optical switch device as defined in claim 1, including a plurality of first and second waveguide paths, each path intersecting one another with said optical element and said heat generator formed at each of said intersections.

17. An optical switch device, comprising:
a first optical waveguide path formed in a glass-like material;
a second optical waveguide path formed in said glass-like material and intersecting said first optical waveguide path at an angle greater than a predetermined critical angle to provide substantially total internal reflection;
a strategically placed optical switching element intersecting said intersecting waveguide paths, said element being thermo-optic and having an offstate index of refraction substantially tailored to match the index of refraction of said waveguide paths, said optical element formed of a polymer capable of producing a change in index of refraction that is sufficient to redirect an optical beam through total internal reflection; and
a thin-film metal heat generator for changing the index of refraction of said optical element to redirect an optical beam whose angle of incidence is greater than said critical angle for total internal reflection which causes said optical beam to be substantially deflected from said first optical waveguide path into said second optical waveguide path, said thin-film heat generator formed above said strategically placed optical element.

18. The optical switch device as defined in claim 17, wherein said optical waveguide paths are buried channel waveguides.

19. The optical switch device as defined in claim 17, wherein said optical waveguide paths are formed from Ge-doped silica.

20. The optical switch device as defined in claim 17, wherein said optical waveguide paths are formed from Silicon Oxynitride.

21. The optical switch device as defined in claim 17, wherein said first and second optical waveguide paths are designed for single mode light beam transmission.

22. The optical switch device as defined in claim 17, including a buffer layer formed over said strategically placed optical element and said thin-film heat generator is deposited on said buffer layer directly above said strategically placed optical element.

23. The optical switch device as defined in claim 17, wherein said thin-film heat generator is formed from Ni-Cr.

24. The optical switch device as defined in claim 17, wherein said thin-film heat generator is formed from Aluminum.

25. The optical switch device as defined in claim 17, wherein said optical element is a polymer formed from a photosensitive monomer.

26. The optical switch device as defined in claim 25, wherein said photosensitive liquid monomer is a difunctional monomer cross-linked when exposed to ultraviolet light to form said optical element.

27. The optical switch device as defined in claim 17, wherein said optical element has a minimum thickness on the order of at least twice the wavelength of said optical beam.

28. The optical switch device as defined in claim 27, wherein said optical element has an optimum thickness on the order of three to four microns.

29. The optical switch device as defined in claim 17, including a plurality of first and second waveguide paths, each path intersecting one another with said optical element and said heat generator formed at each of said intersections.

30. An optical switch device, comprising:
a first optical waveguide path formed in a glass-like material;
a second optical waveguide path formed in said glass-like material and intersecting said first optical waveguide path at an angle greater than a predetermined critical angle to provide substantially total internal reflection;
a strategically placed optical switching element intersecting said intersecting waveguide paths, said element being thermo-optic and having an offstate index of refraction substantially tailored to match the index of refraction of said waveguide paths, said optical element formed of a polymer capable of producing a change in index of refraction that is sufficient to redirect an optical beam through total internal reflection, said optical element polymer formed from a photosensitive monomer; and
a thin-film metal heat generator for changing the index of refraction of said optical element to redirect an optical beam whose angle of incidence is greater than said critical angle for total internal reflection which causes said optical beam to be substantially deflected from said first optical waveguide path into said second optical waveguide path, including a buffer layer formed over said strategically placed optical element and said thin-film heat generator is deposited on said buffer layer directly above said strategically placed optical element.

31. The optical switch device as defined in claim 30 wherein said optical waveguide paths are buried channel waveguides.

32. The optical switch device as defined in claim 30 wherein said optical waveguide paths are formed from Ge-doped silica.

33. The optical switch device as defined in claim 30 wherein said optical waveguide paths are formed from Silicon Oxynitride.

34. The optical switch device as defined in claim 30 wherein said first and second optical waveguide paths are designed for single mode light beam transmission.

35. The optical switch device as defined in claim 30 wherein said thin-film heat generator is formed from Ni-Cr.

36. The optical switch device as defined in claim 30 wherein said thin-film heat generator is formed from Aluminum.

37. The optical switch device as defined in claim 30 wherein said photosensitive monomer is a difunctional monomer cross-linked when exposed to ultraviolet light to form said optical element.

38. The optical switch device as defined in claim 30 wherein said optical element has a minimum thickness on the order of at least twice the wavelength of said optical beam.

39. The optical switch device as defined in claim 30 wherein said optical element has an optimum thickness on the order of three to four microns.

40. The optical switch device as defined in claim 30 including a plurality of first and second waveguide paths, each path intersecting one another with said optical element and said heat generator formed at each of said intersections.

41. A method of making an optical switch, comprising:
forming a first optical waveguide path in a glass-like material;
forming a second optical waveguide path in said glass-like material intersecting said first optical waveguide path at an angle greater than a predetermined critical angle to provide substantially total internal reflection;
forming a strategically placed optical switching element intersecting said intersecting waveguide paths, forming said optical switching element from thermo-optic material having an index of refraction substantially tailored to match the index of refraction of said waveguide paths; and
forming a thin-film metal heat generator for changing the index of refraction of said optical element to redirect an optical beam whose angle of incidence is greater than said critical angle for total internal reflection which causes said optical beam to be substantially deflected from said first optical waveguide path into said second optical waveguide path.

42. The method as defined in claim 41, including forming said optical waveguide paths as buried channel waveguides.

43. The method as defined in claim 41, including forming said optical waveguide paths from Ge-doped silica.

44. The method as defined in claim 41, including forming said optical waveguide paths from Silicon Oxynitride.

45. The method as defined in claim 41, including forming said first and second optical waveguide paths for single mode light beam transmission.

46. The method as defined in claim 41, including forming said optical element from a polymer capable of producing a change in index of refraction that is sufficient to redirect an optical beam through total internal reflection.

47. The method as defined in claim 41, including forming said thin-film heat generator above said strategically placed optical element.

48. The method as defined in claim 47, including forming a buffer layer over said strategically placed optical element and depositing said thin-film heat generator on said buffer layer directly above said strategically placed optical element.

49. The method as defined in claim 41, including forming said optical element with said index of refraction substantially tailored to match the index of refraction of said waveguide paths in an offstate of said optical element.

50. The method as defined in claim 41, including forming said thin-film heat generator from Ni-Cr.

51. The method as defined in claim 41, including forming said thin-film heat generator from Aluminum.

52. The method as defined in claim 46, including forming said optical element from a photosensitive monomer.

53. The method as defined in claim 52, including forming said photosensitive monomer from a difunctional monomer and cross-linking said difunctional monomer by exposure to ultraviolet light forming said optical element.

54. The method as defined in claim 41, including forming said optical element with a minimum thickness on the order of at least twice the wavelength of said optical beam.

55. The method as defined in claim 54, including forming said optical element with an optimum thickness on the order of three to four microns.

56. The method as defined in claim 41, including forming a plurality of first and second waveguide paths with each path intersecting one another and forming said optical element and said heat generator at each of said intersections.

57. A method of switching an optical beam between intersecting light paths, including providing an optical beam in a first optical waveguide path, a second optical waveguide path intersecting the first optical waveguide path at an angle greater than a predetermined critical angle to provide substantially total internal reflection, a strategically placed thermo-optic optical switching element intersecting and having an index of refraction substantially tailored to match the index of refraction of the waveguide paths, comprising:
heating the optical element to change the index of refraction of said optical element to redirect the optical beam whose angle of incidence is greater than said critical angle for total internal reflection to cause said optical beam to be substantially deflected from said first optical waveguide path into said second optical waveguide path.

58. The method as defined in claim 57, including providing buried channel optical waveguide paths formed in a glass-like material.

59. The method as defined in claim 57, including providing optical waveguide paths formed from Ge-doped silica.

60. The method as defined in claim 57, including providing optical waveguide paths formed from Silicon Oxynitride.

61. The method as defined in claim 57, including providing said first and second optical waveguide paths designed for single mode light beam transmission.

62. The method as defined in claim 57, including providing a polymer optical element and heating said element to produce a change in index of refraction sufficient to redirect said optical beam through total internal reflection from said first optical waveguide path into said second optical waveguide path.

63. The method as defined in claim 57, including providing a thin-film heat generator formed above said strategically placed optical element and activating said generator for heating said element.

64. The method as defined in claim 57, including providing said optical element with said index of refraction substantially tailored to match the index of refraction of said waveguide paths in an offstate of said optical element.

65. The method as defined in claim 57, including providing said thin-film heat generator formed from Ni-Cr.

66. The method as defined in claim 57, including providing said thin-film heat generator formed from Aluminum.

67. The method as defined in claim 62, including providing a polymer optical element formed from a photosensitive monomer.

68. The method as defined in claim 67, including providing said photosensitive monomer formed from a difunctional monomer cross-linked by exposure to ultraviolet light to form said optical element.

69. The method as defined in claim 57; including providing said optical element with a minimum thickness on the order of at least twice the wavelength of said optical beam.

70. The method as defined in claim 69, including providing said optical element with an optimum thickness on the order of three to four microns.

71. The method as defined in claim 57, including providing a plurality of first and second waveguide paths, each path intersecting one another with said optical element formed at each of said intersections and selectively heating said optical elements to switch said optical beam therebetween.
